(19) United States
(12) Patent Application Publication
(10) Pub. No.: US 2009/0186597 A1
(43) Pub. Date: Jul. 23, 2009

(54) SYSTEM AND METHOD FOR MANAGING A PHONE BOOK IN A MOBILE PHONE

(75) Inventors: TZU-YEN LIN, Tu-Cheng (TW); CHIEN-CHUNG HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/241,051

(22) Filed: Sep. 30, 2008

(30) Foreign Application Priority Data
Jan. 22, 2008 (CN) 200810300188.6

(51) Int. Cl. H04M 11/00

(52) U.S. Cl. 455/405

(57) ABSTRACT

A method for managing a phone book in a mobile phone is provided. The method sets a priority level for each contact history in a history list based on a type of the contact history, assigns a weight value to each contact history based on the priority level of the contact history. The method further obtains a totalized weight value of each contact by totalizing weight values of all contact histories of the contact, and sorts entries of the contacts in the phone book according to totalized weight values of all the contacts.

### BACKGROUND

1. Field of the Invention

Embodiments of the present disclosure relate to systems and methods for managing information in mobile phones, and particularly to a system and method for managing a phone book in a mobile phone.

2. Description of Related Art

A phone book in a mobile phone may comprise a plurality of contact entries. Each of the contact entries may comprise all kinds of information about a contact, e.g., a name, a phone number, a fax number, a correspondence address, and an e-mail address of the contact. In one method, a user may refer to contact histories when finding a particular contact. These contact entries may include received/missed/dialed calls or received/sent short messages involved with the contact. In another method, the user may refer to the phone book by querying the contact entries in the phone book one by one until the entry of the contact is presented.

However, mobile phones often have many tens or hundreds of contacts making finding a particular contact time-consuming. It may be understood that a listing sequence of the contact histories is based on a time order of generating the contact histories. It may be also understood that the contact entries in the phone book are listed according to a time order of storing the contact entries, or name information of the contacts, such as a Chinese spelling sequence of names of the contacts in the Chinese phonetic alphabet, or Chinese character's writing order of the names of the contacts. As a result, even though some contacts communicate with the user frequently, the user may still spend much time finding a particular contact entry.

What is needed, therefore, is an improved system and method for managing a phone book in a mobile phone, so as to help a user quickly search for the information of frequent contacts.

### SUMMARY

A method for managing a phone book in a mobile phone is provided. The method sets a priority level for each type of contact histories in a history list, assigns a weight value to each contact history, based on a priority level of a type of the contact history. The method further obtain a totalized weight value of each contact by totalizing weight values of all contact histories of the contact, and sorts entries of the contacts in the phone book according to totalized weight values of all the contacts.

Other objects, advantages and novel features of the present disclosure will become more apparent from the following detailed description of certain embodiments of the present disclosure when taken in conjunction with the accompanying drawings.

### BRIEF DESCRIPTION OF THE DRAWINGS

FIG. 1 is a block diagram of one embodiment of a system for managing a phone book in a mobile phone;

FIG. 2 illustrates communication records in a communication list of one embodiment;

FIG. 3 illustrates contacts listed in a phone book before sorting and after sorting of one embodiment; and

FIG. 4 is a flowchart of one embodiment of a method for managing a phone book in a mobile phone.

### DETAILED DESCRIPTION OF CERTAIN INVENTIVE EMBODIMENTS

All of the processes described below may be embodied in, and fully automated via, software code modules executed by one or more general purpose processors. The code modules may be stored in any type of electron-readable medium or other storage device. Some or all of the methods may alternatively be embodied in specialized computer hardware.

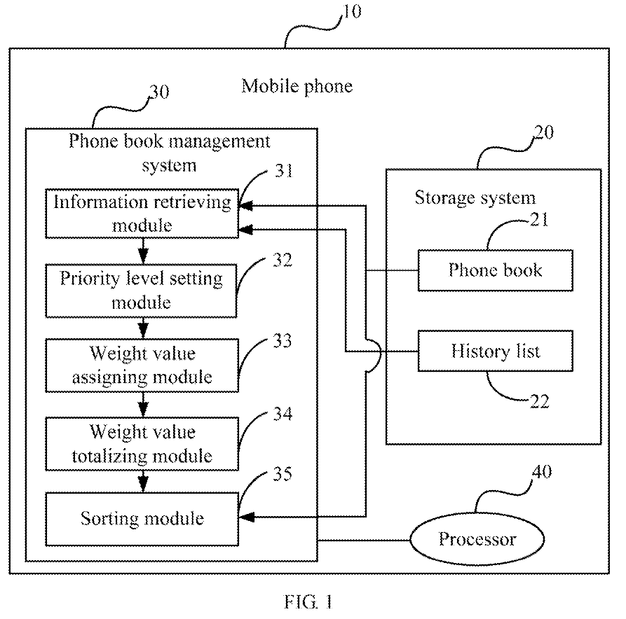

FIG. 1 is a block diagram of one embodiment of a phone book management system 30 for managing a phone book 21 in a mobile phone 10. The mobile phone 10 comprises a storage system 20 for storing the phone book 21 and a history list 22. In one embodiment, the storage system 20 may be an internal memory card of the mobile phone 10. In other embodiment, the storage system 20 may be an external storage card, e.g., a smart media card, a secure digital card, a compact flash card, or any other type of memory card.

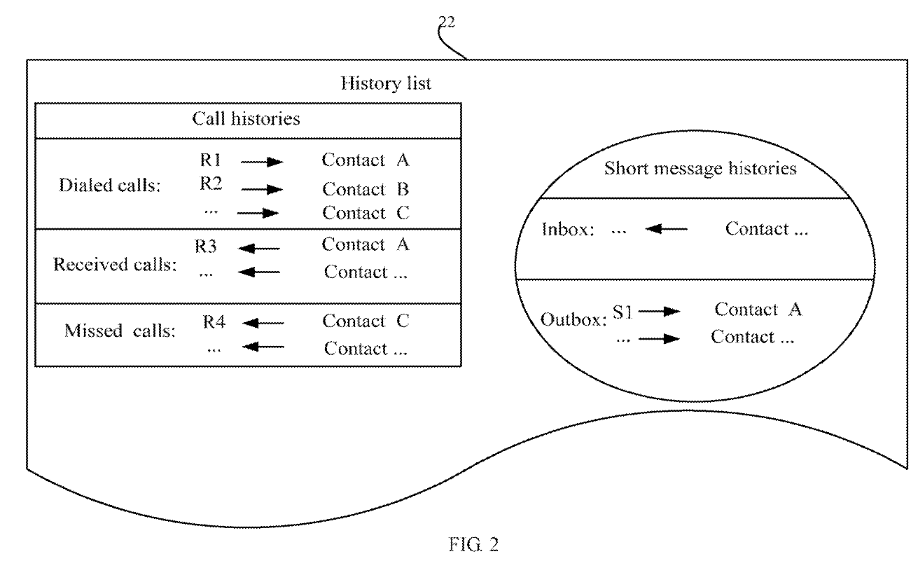

The phone book 21 stores one or more contact entries. Information in each of the entries may comprise a name, one or more phone numbers, and other kinds of information about a contact. The history list 22 stores contact histories, i.e., call histories and short message histories, between each of the contacts and a user of the mobile phone 10. As shown in FIG. 2, in one embodiment, the call histories comprise dialed calls, received call, and missed calls. The short message histories comprise received short messages in an inbox and sent short message in an outbox.

In one embodiment, the phone book management system 30 comprises an information retrieving module 31, a priority level setting module 32, a weight value assigning module 33, a weight value totalizing module 34, and a sorting module 35. The modules 31, 32, 33, 34, 35 may be used to execute one or more operations for the phone book management system 30. One or more general purpose or specialized processors, such as a processor 40 may execute the modules 31-35.

The information retrieving module 31 is configured for retrieving the information of the contacts from the phone book 21, and retrieving the history list 22 from the storage system 20. As shown in FIG. 2, the history list 22 records various types of contact histories, such as call histories comprising dialed calls, received calls and missed calls, and short message histories comprising sent short messages and received short messages.

The priority level setting module 32 is configured for setting a priority level for each type of contact histories in the communication list 22. In one embodiment, the priority level setting module 32 sets a top priority for the dialed calls and the sent short messages, a second priority for the received calls and the received short messages, and a third priority for the missed calls. It may be understood that one contact may have one or more priority levels. As shown in FIG. 2, in the history list 22, there is a dialed call R1, a received call R3, and a sent short message S1 between the user of the mobile phone 10 and a contact B. There is also a dialed call R2 between the user and a contact C, and a missed call R4 from a contact A. Accordingly, the contact B has the top priority and the second priority, the contact C has the top priority, and the contact A has the third priority.

The weight value assigning module 33 is configured for assigning a weight value to each contact history, based on a priority level of the contact history. For example, the weight value assigning module 33 may assign a weight value “3” to each contact history having the top priority level, e.g., the dialed call R1 and the sent short message S1, may assign a weight value “2” to each contact history having the second priority level, e.g., the received call R3, and may assign a weight value “1” to each contact history having the third priority level, e.g., the missed call R4.

The weight value assigning module 33 is further configured for assigning a default weight value to each contact without any contact history. For example, the weight value assigning module 33 assigns a default weight value “0” to a contact D and a contact E without any contact history.

The weight value totalizing module 34 is configured for totalizing weight values of all contact histories of each contact, to obtain a totalized weight value of each contact. For example, a totalized weight value of the contact A is “2,” a totalized weight value of the contact B is “3+3+2,” a totalized weight value of the contact C is “3,” and a totalized weight value of the contact D is “0,” as well as a totalized weight value of the contact E.

The sorting module 35 is configured for sorting the entries of the contacts in the phone book 21 according to totalized weight values of all the contacts. As described above, totalized weight values of the contacts A, B, C, D, and E are 2, 8, 3, 0, and 0. In one embodiment, the sorting module 35 sorts the entries of the contacts according to the totalized weight values from higher to lower, then a listing sequence of the contacts A, B and C after sorting is “B, C, A.”

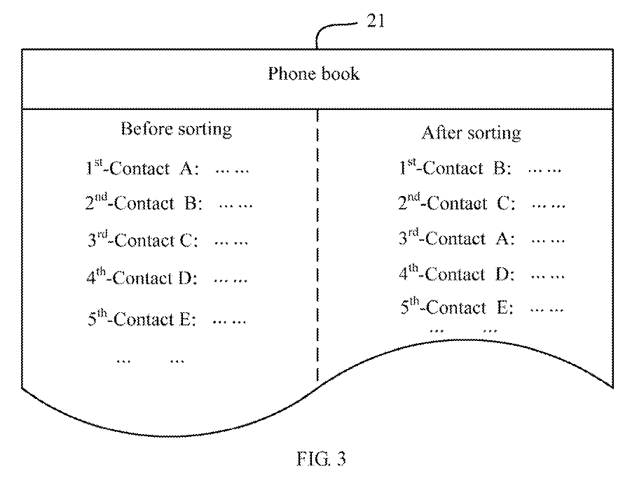

The sorting module 35 is further configured for sorting the entries of the contacts in the phone book having the same totalized weight value based on name information of the contacts in the phone book. In one embodiment, the name information comprises a Chinese spelling sequence of the names of the contacts in the Chinese phonetic alphabet. For example, the contact D and E have the same totalized weight value 0, a name of the contact D is “Li Si,” and a name of the contact E is “Zhang San,” then a listing sequence of the contacts D and E is “D, E.” As shown in FIG. 3, the contacts listed on the left hand are before sorting, and the contacts listed on the right hand are after sorting. In other embodiment, the name information may comprise Chinese character's writing order of the names of the contacts.

Additionally, the sorting module 35 is configured for storing the sorted phone book into the storage system 20.

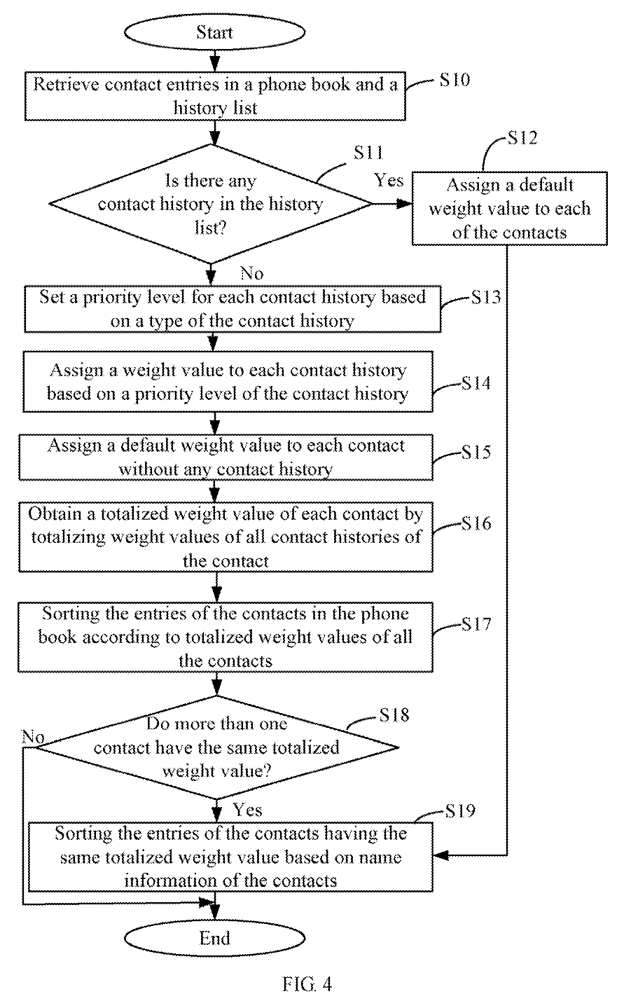

FIG. 4 is a flowchart of one embodiment of a method for managing the phone book 21 in the mobile phone 10. Depending on the embodiment, additional blocks may be added, others removed, and the ordering of the blocks may be changed.

In block S10, the information retrieving module 31 retrieves entries of the contacts from the phone book 21, and retrieves the history list 22 from the storage system 20.

In block S11, the information retrieving module 31 checks if there is any contact history in the history list 22. If there is not any contact history in the history list 22, the procedure goes to block S12. Otherwise, if there is any contact history in the history list, then the procedure goes to block S13.

In block S12, the weight value assigning module 33 assigns a default weight value to each of the contacts in the phone book 21, such as a default weight value “0.” Then, the procedure goes to block S19 as described below.

In block S13, the priority level setting module 32 sets a priority level for each contact history in the communication list 22 according to a type of the contact history. As mentioned above, the priority level setting module 32 sets a top priority for the dialed calls and the sent short messages, a second priority for the received calls and the received short messages, and a third priority for the missed calls. It may be understood that one contact may have one or more priority levels. For example, in the history list 22 in FIG. 2, there is a dialed call R1, a received call R3, and a sent short message S1 between the user of the mobile phone 10 and a contact B. There is also a dialed call R2 between the user and a contact C, and a missed call R4 from a contact A. Accordingly, the contact B has the top priority and the second priority, the contact C has the top priority, and the contact A has the third priority.

In block S14, the weight value assigning module 33 assigns a weight value to each contact history, based on a priority level of the contact history. For example, the weight value assigning module 33 assigns a weight value “3” to each contact history having the top priority level, e.g., the dialed call R1 and the sent short message S1, assigns a weight value “2” to each contact history having the second priority level, e.g., the received call R3, and assigns a weight value “1” to each contact history having the third priority level, e.g., the missed call R4.

In block S15, the weight value assigning module 33 assigns a default weight value to each contact without any contact history. For example, the weight value assigning module 33 assigns a default weight value “0” to a contact D and a contact C without any contact history.

In block S16, the weight value totalizing module 34 obtains a totalized weight value of each contact by totalizing weight values of all contact histories of the contact. For example, a totalized weight value of the contact A is “2,” a totalized weight value of the contact B is “3+3+2,” a totalized weight value of the contact C is “3,” and a totalized weight value of the contact D is “0,” as well as a totalized weight value of the contact E.

In block S17, the sorting module 35 sorts the entries of the contacts in the phone book 21 according to totalized weight values of all the contacts. In one embodiment, the sorting module 35 sorts the entries of the contacts according to the totalized weight values from higher to lower. As described above, totalized weight values of the contacts A, B, C, D, and E are 2, 8, 3, 0, and 0, then a listing sequence of the contacts A, B and C after sorting is “B, C, A.”

In block S118, the sorting module 35 checks if there is more than one contact has the same totalized weight value. If there is more than one contact has the same totalized weight value, for example, the contacts D and E have the same totalized weight value “0,” the procedure goes to block S19.

In block S19, the sorting module 35 sorts the entries of the contacts in the phone book 21 having the same totalized weight value based on name information of the contacts in the phone book. In one embodiment, the name information comprises a Chinese spelling sequence of the names of the contacts in a Chinese phonetic alphabet. For example, the contact D and E have the same totalized weight value “0,” a name of the contact D is “Li Si,” and a name of the contact E is “Zhang San,” then a listing sequence of the contacts D and E is “D, E.” As a result, a listing sequence of the contacts A, B, C, D, and E after sorting is “B, C, A, D, E,” as shown in FIG. 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for managing a phone book in a mobile phone, the method comprising:
retrieving one or more contact histories from a history list stored in a storage system of the mobile phone;
setting a priority level for each contact history according to a type of the contact history;
assigning a weight value to each contact history based on the priority level of each of the contact histories;
totalizing weight values of all contact histories of each contact in the phone book to obtain a totalized weight value of the contact; and
sorting entries of the contacts in the phone book according to totalized weight values of all the contacts.

2. The method of claim 1, further comprising:
assigning a default weight value to each contact without any contact history.

3. The method of claim 1, further comprising:
sorting entries of contacts in the phone book based on information of the contacts stored in the phone book, if the contracts have the same totalized weight value.

4. The method of claim 3, wherein the information comprises a Chinese spelling sequence of names of the contacts in the Chinese phonetic alphabet.

5. The method of claim 3, wherein the information comprises Chinese character's writing order of names of the contacts.

6. The method of claim 1, further comprising:
storing the sorted phone book into the storage system.

7. The method of claim 1, wherein the type of the contact history is selected from the group consisting of a dialed call, a received call, an missed call, a sent short message, and a received short massage.

8. A system for managing a phone book in a mobile phone, the system comprising:
an information retrieving module configured for retrieving one or more contact histories from a history list stored in a storage system of the mobile phone;
a priority level setting module configured for setting a priority level for each contact history according to a type of the contact history;
a weight value assigning module configured for assigning a weight value to each contact history based on the priority level of each of the contact histories;
a weight value totalizing module configured for obtaining a totalized weight value of each contact by totalizing weight values of all contact histories of the contact; and
a sorting module configured for sorting entries of the contact people in the phone book according to totalized weight values of all the contacts.

9. The system of claim 8, wherein the sorting module is further configured for storing the sorted phone book into the storage system.

10. The system of claim 8, wherein the weight value assigning module is further configured for assigning a default weight value to each contact without any contact history.

11. The system of claim 8, wherein the sorting module is further configured for sorting entries of contacts in the phone book having the same totalized weight value based on information of the contacts stored in the phone book.

12. The system of claim 11, wherein the information comprises a Chinese spelling sequence of names of the contacts in the Chinese phonetic alphabet.

13. The system of claim 11, wherein the information comprises Chinese character's writing order of names of the contacts.

14. The system of claim 8, wherein the type of the contact history is selected from the group consisting of a dialed call, a received call, a missed call, a sent short message, and a received short massage.

15. A storage medium storing a set of instructions, the set of instructions capable of being executed by a processor to perform a method for managing a phone book in a mobile phone, the method comprising:
retrieving one or more contact histories from a history list stored in a storage system of the mobile phone;
setting a priority level for each contact history according to a type of the contact history;
assigning a weight value to each contact history based on the priority level of the contact history;
obtaining a totalized weight value of each contact in the phone book by totalizing weight values of all contact histories of the contact; and
sorting entries of the contacts in the phone book according to totalized weight values of all the contacts.

16. The storage medium of claim 15, wherein the method further comprises:
assigning a default weight value to each contact without any contact history.

17. The storage medium of claim 15, wherein the method further comprises:
sorting entries of contacts in the phone book having the same totalized value based on information of the contacts stored in the phone book.

18. The storage medium of claim 17, wherein the information comprises a Chinese spelling sequence of names of the contacts in a Chinese phonetic alphabet.

19. The storage medium of claim 17, wherein the information comprises Chinese character's writing order of names of the contacts.

20. The storage medium of claim 15, wherein the method further comprises:
storing the sorted phone book into the storage system of the mobile phone.
